(19) United States
(12) Patent Application Publication
(10) Pub. No.: US 2003/0226574 A1
(43) Pub. Date: Dec. 11, 2003

(54) Dental floss dispenser

(76) Inventors: Kaupo Padar, Tallinn (EE); Martti Kolk, Tallinn (EE); Mart Enn Koppel, Concord, NH (US)

Correspondence Address: Mart Enn Koppel, 61 South Street Apt 2, Concord, NH, 03301, US

(21) Appl. No.: 10/454,949

(22) Filed: Jun. 5, 2003

(30) Foreign Application Priority Data
Jun. 5, 2002 (EE) U2002 00026
Jun. 5, 2002 (EE) U2002 00027

(51) Int. Cl. A61C 15/00

(52) U.S. Cl. 132/325

(57) ABSTRACT

A dental floss dispenser comprising a elongated, cylindrical housing, and dental floss spool mounted within said housing and dental floss wound on the spool. The dispenser has a cover that can be moved between two positions, so that the content of the dispenser is exposed in a first position and is hidden in a second position of the cover. The cover can be attached to the cylindrical part by pivot so that the cover can be turned around the pivot between first and second position, or the cover can be slidably attached to the cylindrical part of the dispenser so that cover can be move between first and second position.

### BACKGROUND AND SUMMARY OF THE INVENTION

This invention relates to a dental device and a method of manufacturing thereof, and more particularly, a dental floss dispenser that is easy and convenient to carry along during the day.

The importance of good dental hygiene, including the proper care of the teeth by daily cleaning of teeth after each meal is well-recognized. Only brushing teeth is not sufficient for proper cleaning as pieces of food tend to stick between the teeth and are hard to reach by toothbrush. Such pieces smell unpleasantly and create environment that causes further damages to the teeth. Flossing the teeth to remove such pieces after each meal is therefore necessary. Most of the people, however, do not carry dental floss along because the dental floss dispensers are bulky and not attractive.

The objective of the present invention is to provide a dental floss dispenser that is easy and convenient to carry along during the day and can be used discretely wherever and whenever needed.

Another objective is to provide a design for a dental floss dispenser that is easy to manufacture, for example, by using existing equipment suitable for manufacturing writing instruments such as pens and mechanical pencils.

Another objective is to provide a dental floss dispenser that can be combined with and into existing writing instruments, such as pens.

Another objective of the invention is to provide a method for manufacturing dental floss spools based on standard refills for writing instruments such as pens.

### BRIEF DESCRIPTION OF THE DRAWINGS

FIG. 1 is a side view of the dental floss dispenser according to the first embodiment of the invention.

FIG. 2 is a side view of the dental floss spool according to one embodiment of the invention.

FIG. 3 is an element that is used in combination with a dental floss spool depicted on FIG. 4.

FIG. 4 is a short version of a dental floss spool that is used in combination with an element depicted on FIG. 3.

FIG. 5 is a sectioned view of another embodiment of the dental floss spool.

FIG. 6 is another embodiment of the dental floss dispenser.

FIG. 7 is a modification of a middle part of the dental floss dispenser of FIG. 6 with an elongated opening for improved access to the dental floss.

FIG. 8 is a sectioned view of the dental floss spool along line A-A marked in FIG. 5.

FIG. 9 is a sectioned view of the dental floss spool along line B-B marked in FIG. 2.

FIG. 10 is a side view of another embodiment of the dental floss dispenser according to present invention, having rotable top. The dental floss spool and the dental floss are schematically depicted by phantom line.

FIG. 11 is a sectioned view of the dental floss dispenser of FIG. 10 along line C-C whereas the dental floss spool is made of transparent material so that the dental floss can be seen through it.

FIG. 12 is another embodiment of the dental floss dispenser with rotable top.

FIG. 13. is a sectioned view of the dental floss dispenser of FIG. 12 along line D-D whereas the dental floss spool is made of transparent material so that the dental floss can be seen through it.

FIG. 14 is another embodiment of the dental floss dispenser according to present invention, having a orifice to facilitate access to the dental floss, and a slidable cover to cover the orifice, the slidable cover is depicted in its extended, open position.

FIG. 15 is the embodiment of FIG. 14 whereas the slidable cover is in closed position.

FIG. 16. is a partial cross sectional view of the dental floss dispenser of FIGS. 14 and 15 with the slidable cover in its extended, open position.

FIG. 17 is a partial cross sectional view of the dental floss dispensed of FIGS. 14 and 15 with the slidable cover in its closed position.

FIGS. 18 and 19 show one of the designs of a cutter and a fastener usable with different embodiment of the present invention.

FIGS. 20 and 21 show alternative design of the orifice that can be used in combination with embodiments depicted on FIGS. 14 and 22.

FIG. 22 is another embodiment of the invention with slidable cover, and a orifice for easy access of the dental floss.

FIGS. 23 and 24 show the embodiment of FIG. 22 in more details.

FIG. 25 is an end view of the device depicted on FIG. 23.

FIG. 26 is cross sectional view of the cover depicted on FIG. 22.

FIG. 27 is a cross sectional view F-F on FIG. 26.

FIG. 28 is a cross sectional view E-E shown of FIG. 26.

### DETAILED DESCRIPTION OF THE DRAWINGS

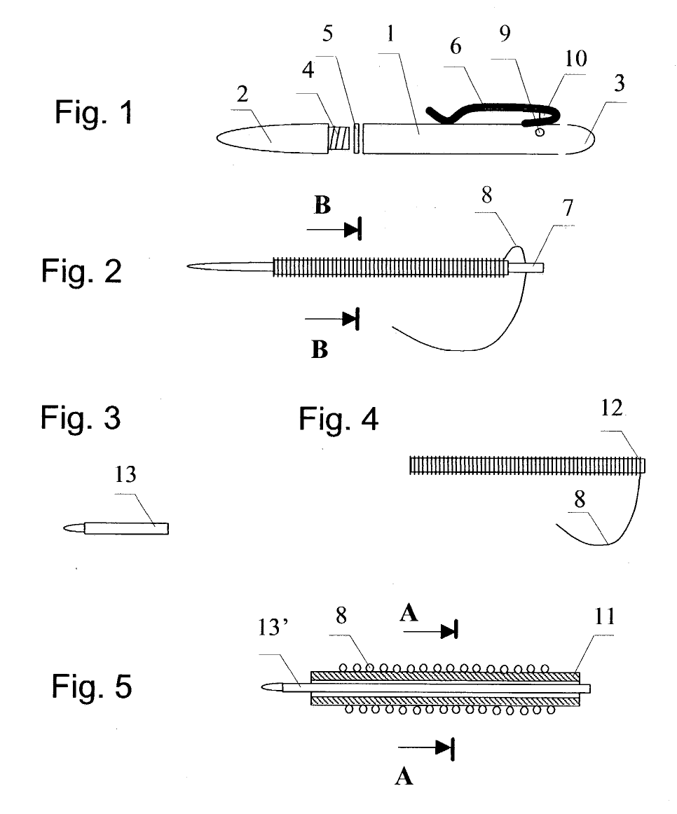

The dental floss dispenser according to present invention is generally of the size of a standard writing instrument, such as pen (preferably, 5 to 15 cm in length and 0.3 to 2 cm in width (in diameter)). The first embodiment is now described with the reference to FIG. 1. The dental floss dispenser has a cylindrical elongated housing that comprises a first cylindrical part 1 and a second cylindrical part 2. The parts are attached to each other by thread joint 4. A washer 5 is disposed between the first and second cylindrical part to facilitate threading as well as for aesthetic reasons. A clip 6 is attached to the first cylindrical part so that the dental floss dispenser can be conveniently stored and carried in pockets, bags, notebooks, organizers, and other places in the same manner as standard writing instruments, such as pens.

An opening 9 is in the first cylindrical part so that the dental floss 8 can be pulled out from the dispenser. A cutter 10 is formed between clip 6 and first cylindrical part 2 for cutting the floss into proper length. The end of the floss is fastened by pinching it between the clipper and the cylindrical part.

Alternatively, a perforated dental floss can be used. Such floss has weaker regions so that the floss can be torn into pieces by applying more force than ordinarily needed for pulling the floss from the dispenser. In this case, there is not need for a cutter.

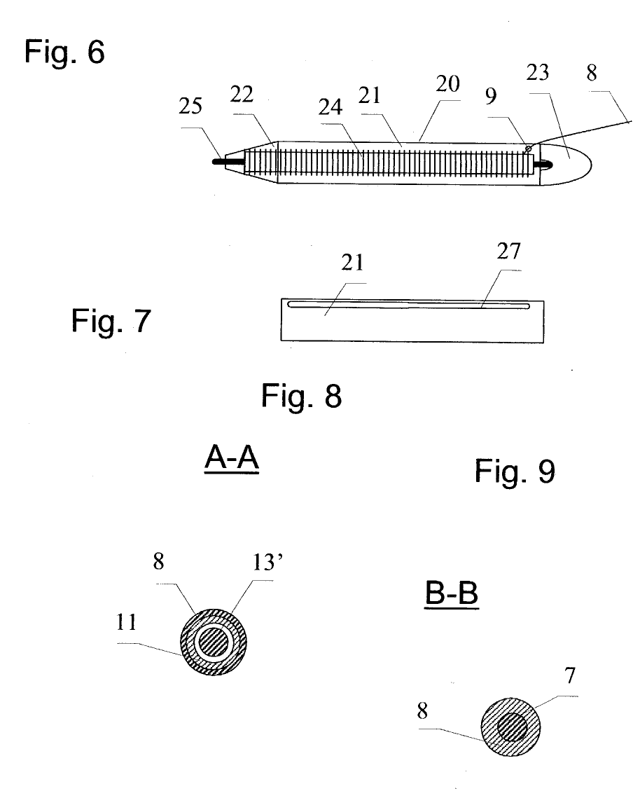

Dental floss 8 is wound on a spool 7. A standard writing instrument refill can be used as a spool (see FIG. 2). However, spool can be wound on a separate spool (see 12 on FIG. 4). The spool can be tubular (see 11 on FIG. 5) or a rod (see 12 on FIG. 4). The spool can be used with a writing instrument (see 13 on FIG. 3, or 13′ on FIG. 4) or without it (see FIG. 6).

Another embodiment is described with a reference to FIG. 6. The dental floss dispenser has a cylindrical body, comprising a first portion 22, a second portion 21 and a third portion 23. A dental floss spool 24 is rotatably mounted on rod 25 within the cylindrical body. The second portion has a generally round opening 9 so that the dental floss 8 can be pulled out of the dispenser. The opening can also be elongated (see opening 27 on FIG. 7). The dispenser can have a clip for hanging the dispenser, a cutter for cutting the floss to the appropriate length, and a fastener for retaining the end of the floss as described relating to the first embodiment (these elements are not shown on FIGS. 6 to 9).

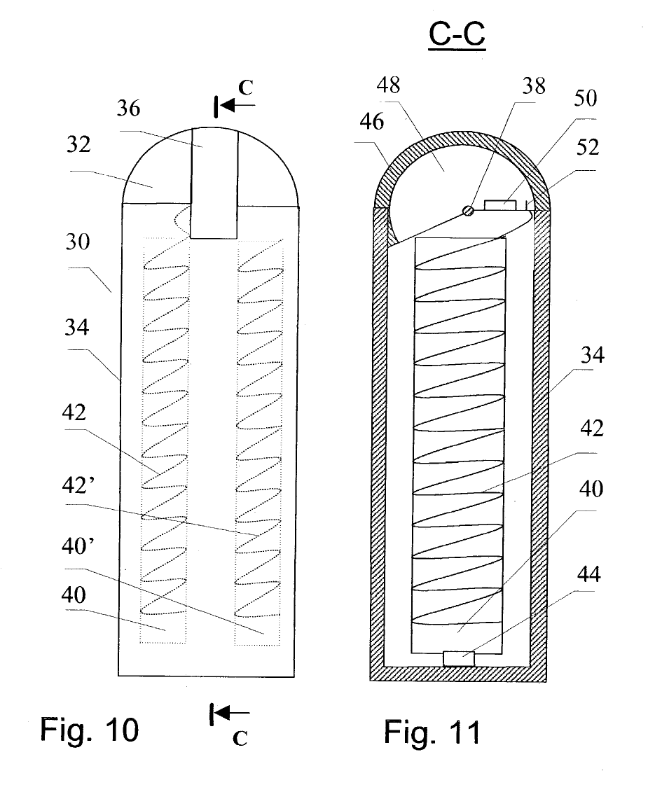

FIGS. 10 and 11 describe another embodiment of the invention. The dental floss dispenser has an elongated housing 30 comprising a cylindrical part 34 and dome-shaped part 32. In the central portion of the dome shaped part 32 is a cover 36 that can be turned between a first, closed position, and a second, open position, where the open area of the cylindrical part is exposed. The content of the dental floss dispenser is exposed when the cover in the open position, namely, two dental floss spools 40 and 40′, and supplies of dental floss 42 and 42′ on these spools. Dental floss spools are attached to the cylindrical part 34 by elements 44 that are well known in the prior art.

The cover 36 is attached to the cylindrical part 34 by pivot 38 that is attached to walls of the cylindrical part 34 so that the pivot is substantially perpendicular with the longitudinal axis of the cylindrical part 34. The cover has a rib 38 and edge 46. Cutter 50 is attached to rib 48. Alternatively, cutter 50 can be formed in the rib itself by sharpening its edge. Also, the cover has fastening means for fastening the end of the dental floss in the form of slit 52. Alternatively, the slit can be formed integrally with the edge 46.

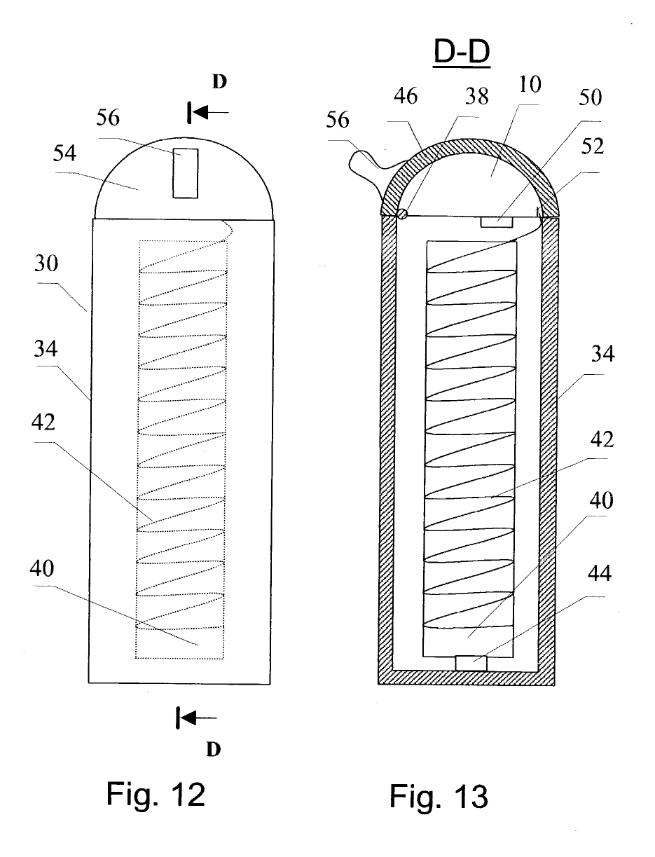

A modification of this embodiment is depicted on FIGS. 12 and 13. The dental floss dispenser according to modification has an elongated housing 30 comprising a cylindrical part 34 and a dome-shaped cover 54. The cover is attached to the cylindrical part by pivot 38. The cover can be turned between first, closed position, and second, open position. The cover has a handle 56 to make it easier to open and close the cover. Alternatively, the cover may be roughened to make it easier to turn with a finger.

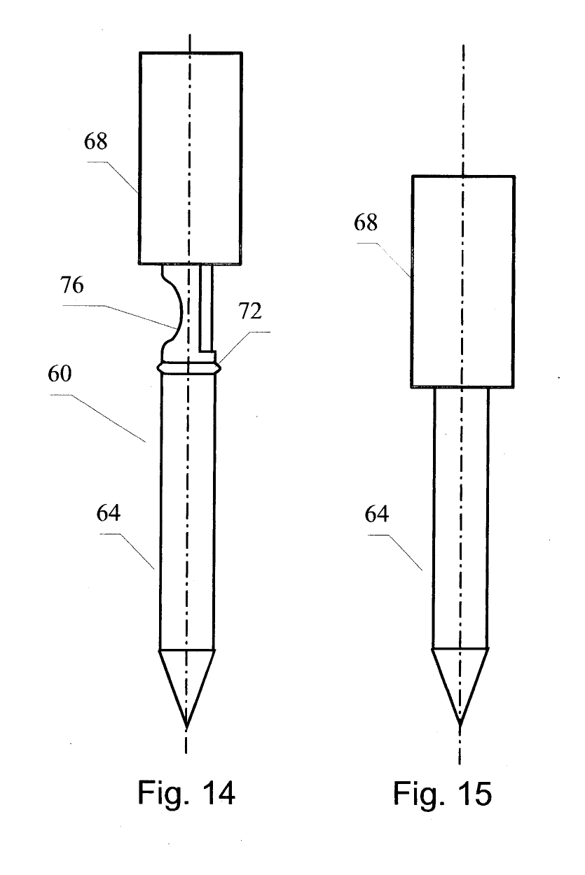

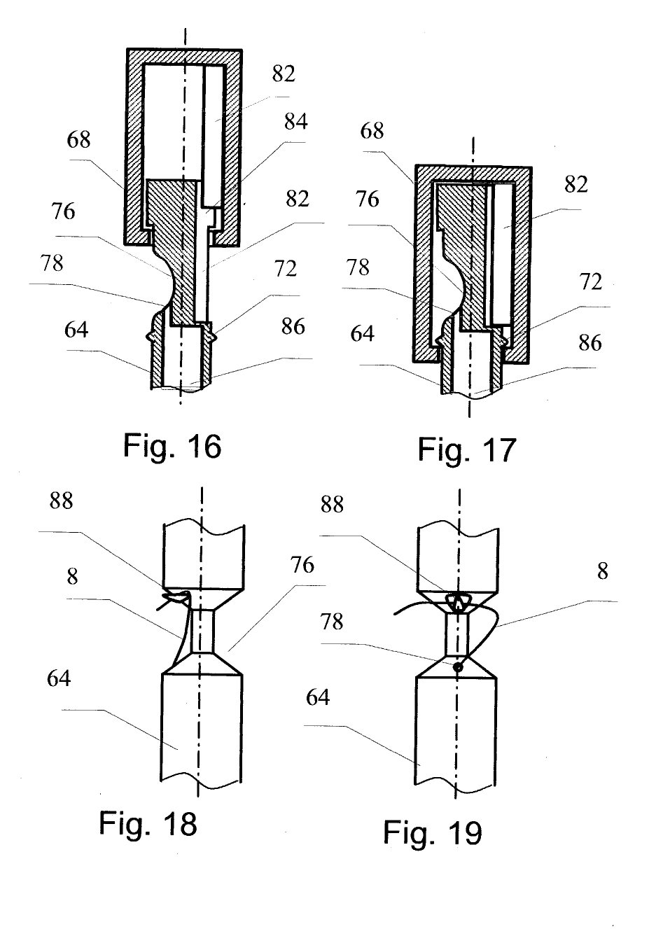

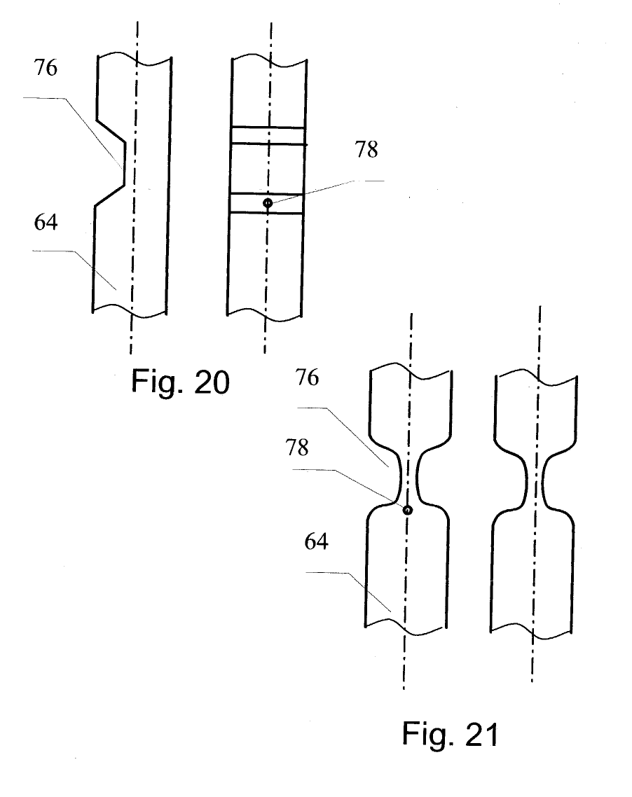

Another embodiment of the invention is depicted on FIGS. 14 to 17. The dental floss dispenser 60 has cylindrical body 64 and a slidable cover 68 thereon. A dental floss spool according to present invention is mounted in the dispenser 86 (the spool is not shown on FIGS. 14 to 17; any of the spools described above can be used in combination with this and with any other embodiments of the invention). The end of the dental floss exits the dental floss dispenser through the opening 78 (see FIGS. 16 and 17) in an orifice 76. A fastener 88 (see FIGS. 18 and 19) is attached to one end of orifice 76. On one end of the orifice is a fastener 88 for fastening the end of the dental floss between uses (see FIGS. 18 and 19). The fastener has one sharpened edge so it also acts as a cutter for cutting the dental floss into appropriate length. The orifice is long enough so that the end of the floss can be conveniently grabbed between thumb and one of the fingers.

The cover 68 can be moved between the first and second position. In the first position (see FIGS. 15 and 17, the cover closes the access to the end of the floss, covering the orifice. The cylindrical part has a stopper 72 and the cover has edges. Force needs to be applied to push the edges over the stopper 72 to keep the cover in a closed position.

Similarly, force is required to slide the cover to open an access to the orifice 78. The extent the cover can move is limited by limiter 84 and edges of the cover. The cover has a tooth 82 and the cylindrical part 64 has a groove to guide the cover while sliding from the open position to the closed position. The tooth and the groove have preferably trapezoidal cross section, but it can also have different cross section.

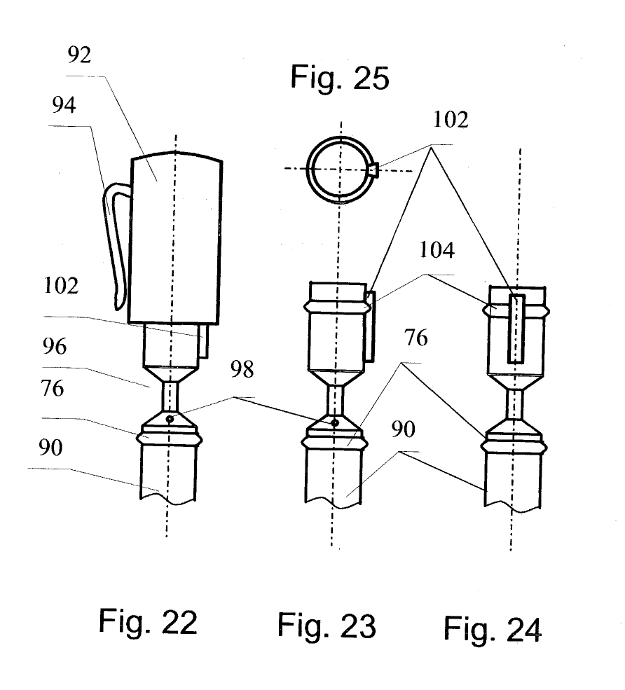

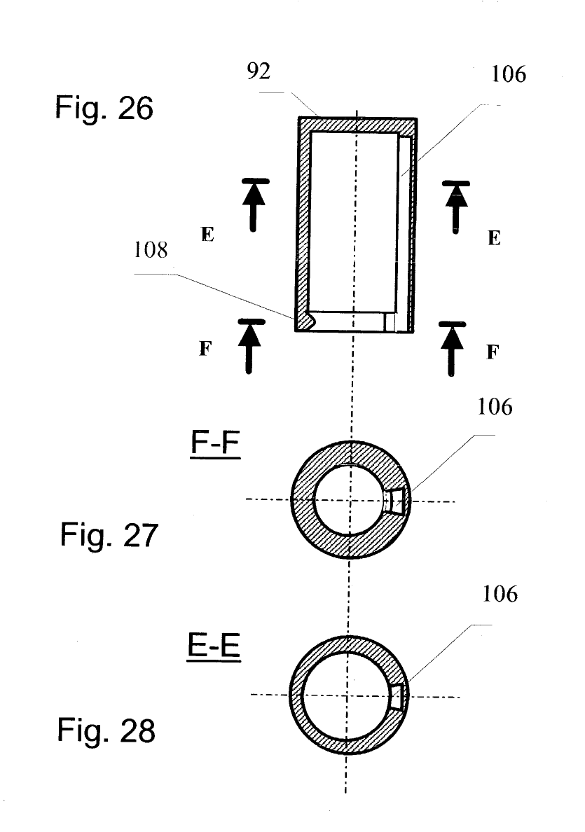

A modified embodiment of the invention is depicted on FIGS. 22-28. The distal floss dispenser has a cylindrical part 90 and slidable cover 92. Clip 94 is attached to the cover to hang the dispenser. The distal floss is pulled from the dispenser through opening 98. An orifice 96 is to facilitate easy access to the floss. Stopper 76 with edges 108 fix the cover in its closes position and limiter 104 with edges 108 stops the cover from sliding over the end of the dispenser. The cylindrical part has a tooth 102 and the cover 92 has a groove 106 to guide the cover while sliding cover 92 from the closed position to the open position.

A method for manufacturing a dental floss spool for using with the dental floss dispenser according to present invention is disclosed. The method comprises:

covering a standard writing instrument refill with a glue;

winding a dental floss on the standard writing instrument.

While the present invention has been illustrated by a limited number of embodiments, it should be understood that modifications and substitutions may be made within the spirit of the invention and the scope of the claims. For example, the cylindrical housing can be made of different materials, including plastic, metal, wood, and glass. The cylindrical housing or any other parts of the dental floss dispenser can be made of transparent material to allow the user to see the amount of dental floss left on the spool, as well as to add attractiveness to the dispenser. The cylindrical housing can have a double layer construction where at least the outer layer is transparent so that information on paper or other suitable materials can be inserted between the layers. The shape of the cross section of the cylindrical housing is generally round, but can also be triangular or rectangular or of any other conceivable shape.

I claim:

1. An elongated dental floss dispenser comprising:
a cylindrical elongated housing having at least one open area;
a dental floss spool mounted within said housing;
a supply of dental floss wound on said dental floss spool, whereas an end of the dental floss is introduced to said open area; and
a cover movable between at least first position and a second position so that said open area is covered in said first position, and is exposed in said second position for easy access to said end of said dental floss.

2. As in claim 1, whereas said cover cover comprises a turnable portion, connected to said cylindrical housing by a hinge, whereas said turnable portion can be turned between said first position, and said second position.

3. As in claim 2, whereas said hinge comprises a pivot that is substantially perpendicular with the longitudinal axis of said cylindrical housing and said pivot extending across said open area.

4. As in claim 2, whereas said cover consist of said turnable portion.

5. As in claim 2, whereas said turnable portion is in the central portion of said cover.

6. As in claim 1, whereas said dental floss container comprises additionally a cutter.

7. As in claim 5, whereas said cutter is connected to said cover.

8. As in claim 2, whereas said cover comprises additionally a rib that is substantially perpendicular to said axis, and parallel to a longitudinal axis of said housing in said second position of said cover.

9. As in claim 8, whereas said cutter is attached to said rib.

10. As in claim 9, whereas said dispenser comprises a fastener for holding the end of said dental floss.

11. As in claim 10, whereas said fastener is connected to said cover.

12. As in claim 8, whereas said rib comprises a fastener for holding the end of said dental floss.

13. As in claim 1, whereas said cover is slidable on said cylindrical housing between said first position and said second position, so that said open area is covered in said first position, and is exposed in said second position.

14. As in claim 13, whereas said comprising limiting means for retaining said cover in said first position, said limiting means comprising a stopper attached to said cylindrical housing, so that an edge of said cover is pushed over said stopper by manual force when the cover is moved to, or from, said first position.

15. As in claim 13, whereas said cover has a tooth and said cylindrical housing has a groove for accepting said tooth for guiding said cover while sliding it from said first position into said second position and from said second position into said first position.

16. As in claim 13, whereas said cylindrical housing has a tooth, and said cover has a groove for accepting said tooth for guiding said cover while sliding it from said first position into said second position and from said second position into said first position.

17. An elongated dental floss dispenser comprising:
a cylindrical housing;
a dental floss spool disposed within said cylindrical housing; and
a dental floss threaded on said dental floss, whereas said cylindrical housing is a standard housing of a writing instrument.

18. As in claim 12, whereas said dental floss spool is rotably mounted on a shaft that extends from one end of said cylindrical housing to another end of said cylindrical housing.

19. As in claim 12, whereas the dental floss spool is a standard refill for a writing instrument.

20. Method of manufacturing a dental floss spool for a elongated dental floss dispenser in the form of standard writing instrument, comprising:
covering a standard writing instrument refill with a glue;
winding a dental floss on the standard writing instrument.
